(19) United States
(12) Patent Application Publication
(10) Pub. No.: US 2002/0064344 A1
(43) Pub. Date: May 30, 2002

(54) Optical coupling device

(75) Inventors: Jocelyn Lauzon, Saint-Augustin-de-Desmaures (CA); Pierre-Yves Cortes, Sillery (CA)

Correspondence Address: MERCHANT & GOULD PC, P.O. BOX 2903, MINNEAPOLIS, MN, 55402-0903, US

(73) Assignee: Institut National D'Optique

(21) Appl. No.: 10/014,775

(22) Filed: Oct. 29, 2001

Related U.S. Application Data
(60) Provisional application No. 60/251,165, filed on Nov. 30, 2000.

(51) Int. Cl. G02B 6/26

(52) U.S. Cl. 385/40; 385/50; 385/51

(57) ABSTRACT

An optical coupling device is provided. The device is based on a substrate in which two channel waveguides are provided. A coupling region is defined in the substrate through which both waveguides lie adjacent to each other. A periodic refractive index change is permanently provided in the coupling region. The periodic refractive index change permanently has a period Λ and enables a coupling between the waveguides of light having a coupling wavelength λ=Λ(n_{eff1}-n_{eff2}), where n_{eff1} and n_{eff2} are average refractive index values of the respective waveguides along the coupling region, n_{eff1} being different from n_{eff2}. An electric field may be applied to the coupling region to allow a tuning of the coupling wavelength.

### FIELD OF THE INVENTION

The present invention relates to the field of optical components and more particularly concerns an optical coupling device.

### BACKGROUND OF THE INVENTION

Optical devices such as wavelength add/drop filters, bandbass filters, directional couplers, etc. are crucial elements of optical communication systems. They are mainly used in DWDM (Dense Wavelength Division Multiplexing) applications, where efficient adding and dropping of channels is essential. It has therefore been a general aim in the industry to provide optical devices having light coupling properties that are increasingly efficient, practical and inexpensive to manufacture.

Known in the art of wavelength couplers is for example U.S. Pat. No. 5,764,831 (LAUZON). This patent concerns a grating-assisted fused fiber filter which couples light between two silica optical fibers using a refractive index grating provided in the fused region of the two fibers.

A particularly desirable caracteristic for optical couplers is wavelength tunability. A wavelength tunable add/drop/ filter is very advantageous since it allows network reconfiguration. Such a device is also useful for wavelength routing of the signal. This characteristic is even more important for metro or access DWDM optical networks where reconfigurations are constant. The market for wavelength tunable bandpass filters is also important, where there is a great advantage to use a tunable filter with fast response time, integrated and with no moving parts (electronic control). An even more advantageous feature of a such a wavelength tunable device is that it may serve as the main building block of an integrated OADM (Optical Add/Drop Multiplexer) if it is combined with, or integrated to, the proper wavelength converter.

A wavelength tunable device is mentioned in U.S. Pat. No. 5,887,089 (Deacon et al). Deacon teaches a structure made of a ferroelectric material having good optoelectronic properties provided with channel waveguides therein. In one embodiment, shown in FIG. 10 of the above mentioned patent, two adjacent waveguides lie in the structure and are provided with a periodically poled structure extending over both of them. Electrodes are provided on either side of the coupling region. When an electric field is applied between the electrodes, the refractive index grating defined by the poled structure is turned on, and coupling is allowed between the two waveguides for light of a given wavelength, determined by the propagation constants of the waveguides and the period of the grating.

In the above-mentioned patent, Deacon explores at length the possibility of tuning the coupling wavelength of such a device. To achieve such a result, one must operate an average refractive index change in the coupling region. To this end, Deacon suggests several techniques, such as using, in the periodic structure, alternate domains of optoelectronic and non-optoelectronic material, using an asymmetric grating to obtain a duty cycle different than 50%, depositing an additional optoelectronic layer over the basic structure, etc. All of the proposed solutions however involve a more complex and costly manufacturing process for the resulting device.

Also known in the art is a coupling device disclosed in R. C. Alferness et al., “Grating-assisted InGaAsP/lnP vertical codirectional coupler filter”, Appl. Phys. Lett., Vol. 55, No. 19, pp. 2011-2013 (1989). Alferness teaches the coupling of light between two planar waveguides made of a semiconductor material. A refractive index grating is provided between the two planes by physically shaping the intermediate semiconductor layers into a periodic structure through etching. Wavelength tunability through the application of an electric field to the structure is mentioned.

### OBJECT AND SUMMARY OF THE INVENTION

It is an object of the present invention to provide a simple optical coupling device.

It is a preferred object of the invention to provide such a coupling device allowing a wavelength tuning of the coupled light.

Accordingly, the present invention provides an optical coupling device including a substrate having a portion thereof defining a coupling region. A first and a second channel waveguide are provided in this substrate. These first and second waveguides extend through the coupling region and are adjacent therealong. A periodic refractive index change, having a period Λ, is permanently provided in the coupling region of the substrate. The periodic refractive index change enables a coupling between the first and second waveguides of light having a coupling wavelength λ given by:

λ=Λ(n_{eff1}−n_{eff2}),

where n_{eff1} and n_{eff2} are average refractive index values of respectively the first and second waveguides along the coupling region, n_{eff1} being different from n_{eff2}.

In accordance with a preferred embodiment of the invention, the substrate is made of an electrooptic material, and the optical coupling device further includes means for generating an electric field having a field amplitude in the coupling region through at least one of the first and second waveguides. The field amplitude of the electric field determines a change of the average refractive index value of the at least one of said first and second waveguides, thereby changing the coupling wavelength λ. Also preferably, the field amplitude may be selectable, thereby allowing a tuning of the coupling wavelength.

Further features and advantages of the present invention will be better understood upon reading of preferred embodiments thereof with reference to the appended drawings.

### BRIEF DESCRIPTION OF THE DRAWINGS

FIG. 1 is a schematic drawing of an optical coupling device according to a first preferred embodiment of the invention.

FIG. 2 is a schematic drawing of an optical coupling device according to a second preferred embodiment of the invention.

FIG. 3A is a diagram showing the wavelength distribution at the coupling between the first and second waveguides of FIG. 2;

FIG. 3B is a diagram showing the wavelength distribution at the coupling between the second and third waveguides of FIG. 2; and

FIG. 3C is a diagram showing the resulting wavelength and bandwidth of light coupled from the first to the third waveguides of the device of FIG. 2.

FIG. 4 shows the spectral distribution for a device according to the embodiment of FIG. 1.

### DESCRIPTION OF PREFERRED EMBODIMENTS OF THE INVENTION

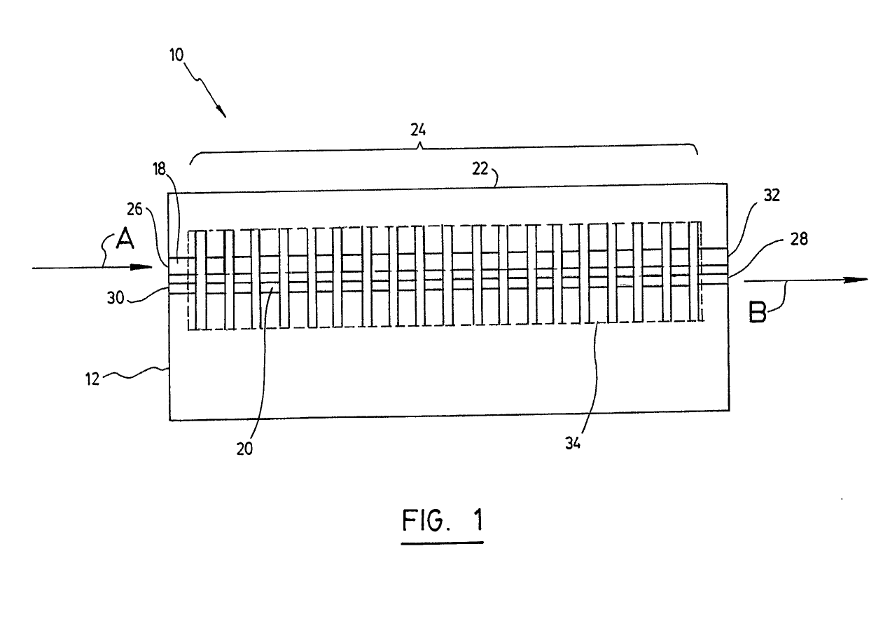

Referring to FIG. 1, there is shown an optical coupling device 10 according to a first preferred embodiment of the present invention.

The device 10 first includes a substrate 12. The substrate 12 is preferably made of a single crystal, which may advantageously have electrooptic or photosensitive properties for preferred embodiments described below. In the preferred embodiment, the substrate consist of a LiNbO₃ crystal. The substrate may have any appropriate size or shape as dictated by the demands of its particular field of application. Although it is illustrated here as a stand-alone device, it is understood that the present invention may be integrated to another optical component, in which case the substrate 12 would be defined as a portion of a more complex device.

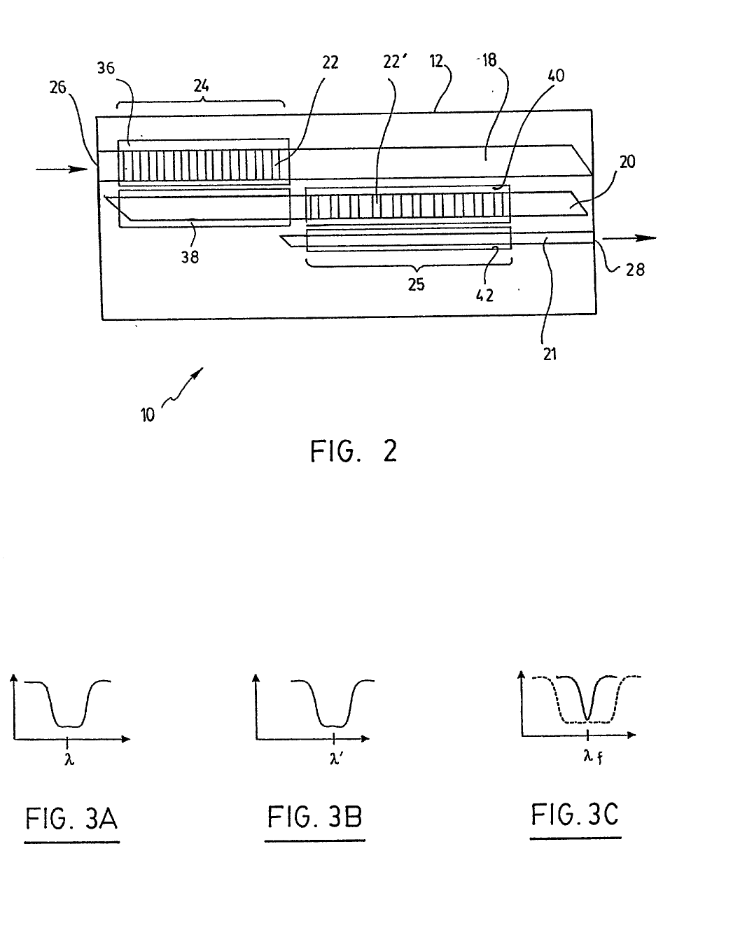

A portion of the substrate 12 defines a coupling region 24. In the illustrated embodiment of FIG. 1, the coupling region extends across most of the length of the substrate 12, but could equally be limited to a small portion thereof, depending on the particulars of the intended use of the device. More than one coupling region may be provided in a given substrate 12, as for example described below with reference to FIG. 2.

A first and a second channel waveguides 18 and 20 are provided in the substrate 12. Both waveguides 18 and 20 extend through the coupling region 24, and are adjacent at least therealong. In the embodiment of FIG. 1, both waveguides 18 and 20 are linear and lie next to each other through the entire length of the substrate 12. The first and second waveguides 18 and 20 are preferably singlemode, and respectively have an average refractive index value n_{eff1} and n_{eff2} in the coupling region 24, n_{eff1} being different n_{eff2}. This may for example be achieved by giving the first and second waveguides 18 and 20 different widths, as shown in FIG. 1.

A periodic refractive index change 22 is provided in the coupling region 24. The periodic refractive index change 22 is permanent. It does not need to be subjected to an electric field to be turned on, the device therefore being useful for application in Passive Optical Network. Preferably, the periodic refractive index change 22 is photoinduced in the substrate 12 by any appropriate technique. In this embodiment, the substrate 12 needs to have photosensitive properties, at least in the coupling region 14. The periodic refractive index change 22 may define a linear Bragg grating, but may also be embodied by a non-linear perturbation such as a chirped or apodised grating, etc. The periodic refractive index change 22 may extend over either or both of the first and second waveguides 18 and 20, in the region in between, or in any portion of the coupling region inasmuch as it is apt to couple light between the two waveguides 18 and 20 through evanescent light coupling. The periodic refractive index change 22 has a period Λ, and therefore enable coupling between the first and second waveguides 18 and 20 of light having a coupling wavelength λ, generally given by the following equation:

λ=Λ(n_{eff1}−n_{eff2})

The above relation applies for the whole grating in the case where the period Λ is constant or locally if it is non-linear.

In the preferred embodiment, a first input 26 is connected to the first waveguide 18, upstream the coupling region 24. The first input 26 is for receiving, in operation, an incoming light beam A. A first output 28 is similarly connected to the second waveguide 20, downstream the coupling region 24, for exiting a light beam B resulting from the filtering operation of the device 10. Also preferably, a second input 30 and a second output 32 may respectively be connected to the second waveguide 20 upstream the coupling region and to the first waveguide 18 downstream the coupling region. In this case, the remaining portion of the light beam A which has not been coupled to the second waveguide 20 may therefore be outputted separately if needed. Of course, all inputs and outputs may be fiber pigtailed in order to be useful for optical communication applications. The extremities of the waveguides 18 and 20 connected to the second output and input may also be left free, in which case they are preferably angled at more than 100 to eliminate back reflections in the waveguides.

Still referring to FIG. 1, according to a particularly advantageous embodiment of the invention, the substrate 12 has electrooptic properties, and the device 10 further includes means for generating an electronic field in the coupling region 24, such as a pair of electrodes 34 extending on either sides of the substrate 12. The field may be applied to both waveguides 18 and 20 or the just one of them. In this manner the average refractive index value of the affected waveguide or waveguides is changed in a manner proportional to the field amplitude. This will in turn change the coupling wavelength λ in accordance with the equation above. In one embodiment, turning the electric field on and off will allow the device to switch between two discreet coupling wavelengths. In another embodiment the field amplitude of the electric field may be selectable, thereby allowing a tuning of the coupling wavelength λ.

It should be noted that the present invention is not limited to the electrode configuration illustrated above, but includes all appropriate means of generating the electric field. For example, as shown in the embodiment of FIG. 2, two pairs of electrodes could be provided for each coupling region, a first pair extending on either side of the first waveguide 18, and a second pair extending on either side of the second waveguide 20. This configuration advantageously allows to generate an electric field of different values in each waveguide. Alternatively, the electrodes could be co-lateral, or the electric field could be produced by a more elaborate structure. It is understood that the expression “electric field” used herein could be a combination of several field components applied in different regions.

Referring to FIGS. 2, 3A, 3B and 3C, there is shown a second embodiment of the present invention where the bandwidth of the coupled beam is also tunable.

In this embodiment, the substrate 12 is provided with a third waveguide 21 in addition to first and second waveguides 18 and 20. Of course, additional waveguides could be added to the substrate 12, if needed. A first coupling region 24 is provided along the first and second waveguides 18 and 20, as before, and a secondary coupling region 25, similar to the first one, is here provided along the second and third waveguides 20 and 21. A periodic refractive index change 22 and a secondary periodic refractive index change 22′ are respectively provided in the coupling region 24 and secondary coupling region 25. The secondary periodic refractive index change 22 has a period Λ′ and enables a coupling between the second and third waveguides 20 and 21 of light having a coupling wavelength λ′ given by:

λ′=Λ(n_{eff2}−n_{eff3}),

where n_{eff3} and n_{eff2} are average refractive index values of respectively the second and third waveguides 20 and 21 along the second coupling region 25, n_{eff2} being different from n_{eff3}. As explained with respect to the embodiment of FIG. 1, the refractive index change in each coupling region is permanent, and is preferably photoinduced in the substrate 12. The periodic refractive index change 22 of each coupling region is preferably of a short length, preferably of less than 10 mm, which results in a relatively large bandwidth of the coupled signal, of the order of 10 nm or larger.

Means for generating a first electric field, in the first coupling region, are provided and preferably include pairs of electrodes 36 and 38, respectively disposed on either side of the first and second waveguides. Similarly, a second electric field is generated in the second coupling region by pairs of electrodes 40 and 42. The amplitude of both electric fields is adjustable to tune the coupling wavelength of each coupling region independently.

In operation, a multiwavelength optical signal is inserted into input 26 of the first waveguide 18. In the first coupling region 24, a portion of the input beam centered on the coupling wavelength λ, and having a first bandwidth determined by the grating's geometry, is coupled from the first to the second waveguides 18 and 20. The spectral profile of the resulting beam propagating in the second waveguide 20 is schematized in FIG. 3A. When it reaches the second coupling region 25, a portion of this beam centered on the coupling wavelength λ′ and having a second bandwidth is coupled into the third waveguide 21, from which it exits at output 28. FIG. 3B shows the coupling spectral shape of the second coupling region, and FIG. 3C shows the superposition of the graphs of FIGS. 3A and 3B, and the spectral shape of the resulting beam coupled from the first to the third waveguides 18 and 21.

As can be seen, both the coupling wavelength λ_{f} and the bandwidth of the output beam will simply depend on the overlap between the bandwidths of the first and second coupling regions 24 and 25. The bandwidths being fixed values, both parameters are easily controlled by simply calculating the required values of the two coupling wavelengths λ and λ′, and setting the amplitude of the first and second electric fields accordingly.

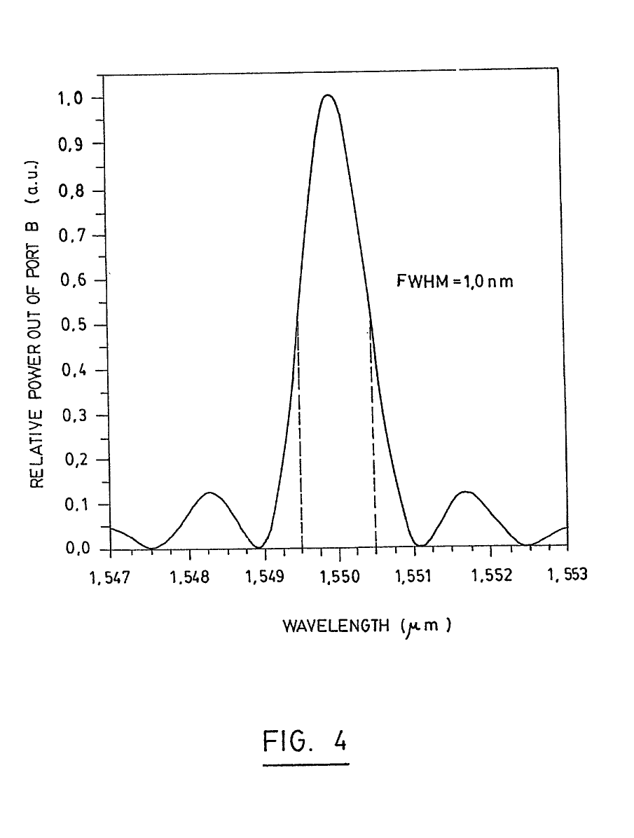

Referring to FIG. 4, there is shown an example of the expected response of a device according to FIG. 1, when used to filter into output 28 a spectral portion of a beam incident at input 26. In this case, the interaction length between the first and second waveguides is taken to be approximately 25 mm, the distance between the waveguides is set to about 2 μm, Δβ to 6300 cm⁻¹ and Λ to approximately 10 μm. The expected tunability is of 30 nm for an operational voltage of approximately 20 V.

One skilled in the art will readily understand that devices as described above have many applications in the field of optical communications. For example, in a simple embodiment it may serve as a bandpass filter where only the first input 26 and first output 28 are provided. Alternatively a second input 30 and second output 32 may be used to make a bidirectional add/drop filter, or a directional coupler where a signal of a given wavelength may be routed to either output 28 or 32 by choosing the proper voltage. In the two latter cases, it may be advantageous to choose a geometry where the waveguides are apart at both ends and are curved so as to come together over the coupling region only. In another potential application, a device according to the present invention may be used in an optical attenuator where the optical power output of a signal may be changed by tuning in or out a certain wavelength range therefrom. Other possible applications include a wavelength selective optical switch, an optical modulator, etc.

Of course numerous changes could be made to the embodiments described above without departing from the scope of the invention as defined in the appended claims.

What is claimed is:

1. An optical coupling device, comprising:
a substrate having a portion thereof defining a coupling region;
a first and a second channel waveguide provided in said substrate, said first and second waveguides extending through the coupling region and being adjacent therealong; and
a periodic refractive index change permanently provided in said coupling region of the substrate and having a period Λ, said periodic refractive index change enabling a coupling between the first and second waveguides of light having a coupling wavelength λ given by:
λ=Λ(n_{eff1}−n_{eff2}),
where n_{eff1} and n_{eff2} are average refractive index values of respectively the first and second waveguides along the coupling region, n_{eff1} being different from

2. An optical coupling device according to claim 1, further comprising:
a first input connected to the first waveguide upstream the coupling region; and
a first output connected to the second waveguide downstream the coupling region.

3. An optical coupling device according to claim 2, wherein said first input and output are fiber pigtailed.

4. An optical coupling device according to claim 2, further comprising a second output connected to the first waveguide downstream the coupling region.

5. An optical coupling device according to claim 4, further comprising a second input connected to the second waveguide upstream the coupling region.

6. An optical coupling device according to claim 5, wherein said first and second inputs and first and second outputs are fiber pigtailed.

7. An optical coupling device according to claim 1, wherein said substrate is made of a photosensitive material, the periodic refractive index change being photoinduced therein.

8. An optical coupling device according to claim 7, wherein said photosensitive material is a LiNbO₃ crystal.

9. An optical coupling device according to claim 1, wherein the first and second waveguides are singlemode waveguides.

10. An optical coupling device according to claim 1, wherein the first and second waveguides have different widths.

11. An optical coupling device according to claim 1, wherein the substrate is made of an electrooptic material, said optical coupling device further comprising means for generating an electric field having a field amplitude in the coupling region through at least one of the first and second waveguides, said field amplitude of the electric field determining a change of the average refractive index value of the at least one of said first and second waveguides, thereby changing the coupling wavelength λ.

12. An optical coupling device according to claim 11, wherein the field amplitude of the electric field is selectable, thereby allowing a tuning of the coupling wavelength λ.

13. An optical coupling device according to claim 11, wherein the means for generating an electric field comprise a pair of electrodes.

14. An optical coupling device according to claim 13, wherein said electrodes respectively extend over and under the substrate, the coupling region extending therebetween.

15. An optical coupling device according to claim 1, wherein:
a secondary coupling region is provided in the substrate;
a third channel waveguide is further provided in said substrate, the second and third waveguides extending through the secondary coupling region and being adjacent therealong; and
a secondary periodic refractive index change is permanently provided in the second coupling region and has a period Λ′, said secondary periodic refractive index change enabling a coupling between the second and third waveguides of light having a coupling wavelength λ′ given by:
λ′=Λ(n_{eff2}−n_{eff3}),
where n_{eff3} and n_{eff2} are average refractive index values of respectively the second and third waveguides along the second coupling region, n_{eff2} being different from n_{eff3}.

16. An optical coupling device according to claim 15, wherein said substrate is made of a photosensitive material, the periodic refractive index change and secondary periodic refractive index change being photoinduced therein.

17. An optical coupling device according to claim 15, wherein the substrate is made of an electrooptic material, said optical coupling device further comprising:
means for generating a first electric field having a selectable field amplitude in the coupling region through at least one of the first and second waveguides, said field amplitude of the first electric field determining a change of the average refractive index value of the at least one of said first and second waveguides, thereby changing the coupling wavelength λ; and
means for generating a second electric field having a selectable field amplitude in the secondary coupling region through at least one of the second and third waveguides, said field amplitude of the second electric field determining a change of the average refractive index value of the at least one of said second and third waveguides, thereby changing the coupling wavelength λ′,
the device thereby enabling a coupling of light of a tunable wavelength and tunable bandwidth from the first to the third waveguide.
